(19) United States
(12) Patent Application Publication
(10) Pub. No.: US 2012/0052362 A1
(43) Pub. Date: Mar. 1, 2012

(54) THERMOPLASTIC FILM, METHODS FOR MAKING SUCH FILM, AND THE USE OF SUCH FILM AS BATTERY SEPARATOR FILM

(75) Inventors: Derek Thurman, Houston, TX (US); Patrick Brant, Houston, TX (US); Kazuhiro Yamada, Tochigi (JP); Koichi Kono, Tochigi (JP)

(73) Assignee: TORAY TONEN SPECIALTY SEPARATOR GODO KAISHA, Nasushiobara, Tochigi (JP)

(21) Appl. No.: 13/264,045

(22) PCT Filed: Apr. 7, 2010
(86) PCT No.: PCT/US2010/030249

§ 371 Date: Nov. 14, 2011

Related U.S. Application Data
(60) Provisional application No. 61/172,071, filed on Apr. 23, 2009.
(60) Provisional application No. 61/172,075, filed on Apr. 23, 2009.
(60) Provisional application No. 61/218,728, filed on Jun. 19, 2009.

(30) Foreign Application Priority Data
Jul. 15, 2009 (EP) 09165554.8

(51) Int. Cl. H01M 2/16; B32B 27/32; B29C 70/18; B32B 5/02

(52) U.S. Cl. 429/145; 442/394; 442/398; 442/381; 156/166

(57) ABSTRACT

A thermoplastic film including a microporous polymeric membrane; and a non-woven web comprising a plurality of fibers, the web being bonded to the microporous polymeric membrane, wherein the fibers comprise oxidation-protective polymer having an MFR ≧2.0×10².

### PRIORITY CLAIM

This application claims priority to and the benefit of U.S. Ser. No. 61/218728, filed Jun. 19, 2009, U.S. Ser. No. 61/172071, filed Apr. 23, 2009, U.S. Ser. No. 61/172075, filed Apr. 23, 2009, and European Application No. EP 09165554.8, filed Jul. 15, 2009, the contents of each of which are incorporated by reference in their entirety.

### FIELD OF INVENTION

The invention relates to thermoplastic film, methods for making thermoplastic film, and the use of thermoplastic film as battery separator film. More particularly, the invention relates to a thermoplastic film comprising a microporous polymeric membrane and a non-woven polymeric web comprising an oxidation-protective polymer. The non-woven polymeric web can be a meltblown polymeric layer on the microporous polymeric membrane.

### BACKGROUND

Microporous membranes have been used as battery separators in primary and secondary lithium batteries, lithium polymer batteries, nickel-hydrogen batteries, nickel-cadmium batteries, nickel-zinc batteries, and silver-zinc secondary batteries. The performance of such microporous membranes significantly affects the properties, productivity, and safety of the battery.

It is generally desirable for the battery separator film to be resistant to oxidation, particularly in batteries subjected to relatively high temperatures as can occur under overcharge or rapid-discharge conditions. Battery separator film oxidation can lead to a loss in the battery's electrochemical activity, which generally results in a battery voltage decrease.

It is also desirable for the battery separator film to have a relatively low shutdown temperature (“SDT”) and relatively high meltdown temperature (“MDT”) for improved battery-safety. Battery separator film is generally produced with a relatively high permeability for the battery's electrolyte. It is desirable for the battery separator film to retain its electrolyte permeability while the battery is exposed to relatively high temperatures (but below SDT), as might be encountered during battery manufacturing, testing, and use, so that the battery does not experience an undue loss of power or capacity.

U.S. Pat. No. 6,692,868 B2 discloses a meltblown layer laminated on microporous film to lower the film's SDT. The reference discloses a meltblown polyolefin layer having a basis weight of from 6 to 160 grams per square meter, wherein 50% of the fibers have a diameters of less than 0.5 μm. The reference discloses that the web can be laminated on a membrane substrate to produce a battery separator film having a shutdown feature.

The production of meltblown fibers is generally described in U.S. Pat. No. 3,849,241, U.S. Pat. No. 4,526,733, and U.S. Pat. No. 5,160,746. A web of meltblown polyethylene fibers has been used for separators in NiMH batteries as disclosed in U.S. Pat. No. 6,537,696 and U.S. Pat. No. 6,730,439. These separators, however, are not useful for Li ion batteries because the disclosed monolithic meltblown fabrics have low tensile and puncture strength, and large pore size.

To compensate for low strength, laminates of meltblown and spunbond non-woven layers have been produced to improve separator mechanical properties, but this can be undesirable because separator thickness is increased.

While improvements have been made, there is still a need for relatively thin thermoplastic film useful as battery separator film, the thermoplastic film having a low SDT and capable of retaining high permeability during battery manufacturing and use.

### SUMMARY

In an embodiment, the invention relates to a thermoplastic film comprising:

a microporous polymeric membrane; and

a non-woven web comprising a plurality of fibers, the web being bonded to the microporous polymeric membrane, wherein the fibers comprise oxidation-protective polymer having an MFR ≧2.0×10². Optionally, the oxidation-protective polymer is a polypropylene composition comprising a first polypropylene having a Tm ≧149.0° C. and a ΔHm ≧80.0 J/g C and/or a second polypropylene having a Tm in the range of 85.0° C. to 130.0° C. and a Te−Tm≦10°.

In another embodiment, the invention relates to a method for producing a thermoplastic film comprising combining a non-woven web and a microporous polymeric membrane, the web comprising a plurality of fibers, the fibers comprising oxidation-protective polymer having an MFR ≧2.0×10². Optionally, the oxidation-protective polymer is a polypropylene composition comprising a first polypropylene having a Tm ≧149.0° C. and a ΔHm ≧80.0 J/g C and/or a second polypropylene having a Tm in the range of 85.0° C. to 130.0° C. and a Te−Tm≦10°. The invention also relates to the membrane product of such a process.

In yet another embodiment, the invention relates to a battery comprising an anode, a cathode, an electrolyte, and a separator situated between the anode and the cathode, the separator comprising:

a microporous polymeric membrane; and

a non-woven web comprising a plurality of fibers, the web being bonded to the microporous polymeric membrane, wherein the fibers comprise oxidation-protective polymer having an MFR ≧2.0×10². Optionally, the oxidation-protective polymer is substantially the same polypropylene as in the preceding embodiments.

### DETAILED DESCRIPTION

The invention is based in part on the discovery that applying a non-woven web comprising an oxidation-protective polymer (such as polypropylene homopolymer or copolymer) to a microporous polymeric membrane substrate results in a battery separator film (“BSF”) having improved electrochemical stability compared to a BSF comprising the microporous membrane alone. This is surprising since the non-woven web is in the form of fibers having a relatively large average diameter, wherein the fibers contact only a portion of the substrate's surface. Such a web provides electrochemical stability (i) even at BSF temperatures where the oxidation-protective polymer is not in the molten state and consequently remains confined in the web's fibers and (ii) even though a significant portion of the substrate's surface is exposed to the web's pores. The web can be bonded to the microporous membrane to produce the thermoplastic film. For example, the web can be meltblown on a microporous membrane (e.g., as a layer or coating). Alternatively, the web can be first meltblown away from the microporous membrane and then joined to the microporous membrane, e.g., by lamination (such as thermal or sonic bonding) or with an adhesive.

The invention is also based on the discovery of a thermoplastic film useful as a BSF, wherein the thermoplastic film comprises a microporous polymeric membrane having at least one multi-functional, non-woven web contacting the microporous membrane. Such a multi-functional web provides or enhances at least two BSF functionalities, e.g., two or more functionalities selected from meltdown temperature, shutdown temperature, permeability, porosity, strength, electrochemical stability, etc., and optionally three or more of such BSF functionalities.

For example, in a BSF comprising a multi-functional non-woven polymeric web contacting a microporous membrane substrate, the web can provide the BSF with, e.g., (i) both improved SDT and electrochemical stability over that of the microporous membrane substrate, (ii) both improved MDT and electrochemical stability over that of the substrate, or (iii improved SDT, MDT, and electrochemical stability over that of the substrate. The polymer used to produce the non-woven web will now be described in more detail.

### Polymer Used to Produce the Non-Woven Web

In an embodiment, the non-woven web comprises oxidation-protective polymer, For the purposes of this specification and appended claims, the term “oxidation-protective polymer” means (i) polyphenylene sulfide, polyphenylene oxide, nylon, polyester (e.g., polyethylene terephthalate and polybutylene terephthalate), liquid-crystalline polymer, and combinations thereof; and/or (ii) polymer comprising units derived from ≧90.0 mol. % of one or more C3-C10 monomers and ≦10.0 mol. % of ethylene. The group (ii) oxidation-protective polymers have tertiary carbon atoms, and optionally have ≧3.0×10³ tertiary carbon atoms per 1.0×10⁴ carbon atoms based on the total number of carbon atoms in the polymer. A tertiary carbon atom is a carbon atom having three nearest-neighbor carbon atoms. The number of tertiary carbon atoms per 1.0×10⁴ carbon atoms can be measured by conventional proton-NMR for example. The oxidation-protective polymers are substantially free of post-polymerization Mw-reduction species, e.g., peroxides. Substantially-free in this context means the oxidative-protective polymer contains ≦100.0 ppm of such post-polymerization Mw reduction species, e.g., ≦50.0 ppm of such species, such as ≦10.0 ppm of such species, based on the weight of the oxidation-protective polymer.

In an embodiment, the oxidation-protective polymer comprises homopolymer including combinations of homopolymers, e.g., mixtures or reactor blends. In another embodiment, the oxidation-protective polymer comprises copolymer containing ≦10.0 mol. % of at least one comonomer, such as one or more of ethylene, propylene, butene, hexene. octene, or decene; including combinations of such copolymers and combinations of homopolymer(s) and such copolymers.

It is believed that the group (i) oxidation-protective polymers protect the microporous membrane by shielding the membrane from chemically active species (e.g., oxidizing species). It is believed that the group (ii) oxidation-protective polymers protect the microporous membrane by providing tertiary carbon atoms capable of reacting with chemically active species, in order to prevent reactions among these species and the microporous membrane.

Although the oxidation-protective polymers are compatible with additive species that are capable of improving polymer oxidation resistance (e.g., tetrakis[methylene-3-(3,5-ditertiary-butyl-4-hydroxyphenyl)-propionate] methane), such additive species are not required. In an embodiment, the oxidation-protective polymer contains ≦5.0 wt. %, or ≦1.0 wt. % of such additive species, based on the weight of the oxidation-protective polymer. It has been discovered that the web's oxidation-protective polymer protects the microporous membrane from oxidation and improves the membrane's electrochemical stability even without the use of such additional species.

Optionally, the oxidation-protective polymer of group (ii) has a ratio of the average number of tertiary carbon atoms in the oxidation-protective polymer's backbone to the total number of carbon atoms in the polymer's backbone in the range of 1.0:1.0 to 1.0:10, such as in the range of 1.0:1.0 to 1:5.0, e.g., 1.0:2.0. Examples of oxidation-protective polymers include polypropylene, polyhexene, poly(4-methylpentene-1), and poly(vinylcyclohexane), and combinations thereof.

In an embodiment, the non-woven web comprises oxidation-protective polymer in an amount ≧30.0 wt. %, e.g., ≧50.0 wt. %, such as in the range of 75.0 wt. % to 100.0 wt. %, 90.0 wt. % to 100.0 wt. %, based on the weight of the non-woven web. While the following description primarily concerns the use of polypropylene as oxidation-protective polymer for producing the non-woven web, the invention is not limited thereto, and the description is not meant to foreclose the use of additional or other oxidation-protective polymers within the broader scope of the invention.

In an embodiment, the non-woven web comprises polypropylene, including, e.g., mixtures (such as physical blends) or reactor blends of polypropylenes, where the polypropylene comprises polymer containing recurring propylene units. Examples of such polypropylene include polypropylene homopolymer and copolymers of propylene and at least a second monomer. Optionally, the polypropylene comprises polypropylene homopolymer and/or polypropylene copolymer wherein at least 90% (by number) of the recurring units are propylene units. Optionally, the polypropylene is a polymer capable of forming a non-woven web in a meltblowing process, such as a polypropylene having a melt flow rate (“MFR”) ≧2.0×10². In an embodiment, the polypropylene comprises a polypropylene composition, e.g., a composition comprising one or more polypropylene homopolymers or copolymers and optionally further comprising additional polymers or combinations of polymers such as additional polyolefin or combinations of polyolefins.

In an embodiment, the oxidation-protective polymer (i.e., polypropylene) is a reactor grade copolymer, meaning that it has not been subjected to a post polymerization chemical process such as chain scissioning, grafting, etc., that will alter its weight average molecular weight (Mw) by more than about 2.0%. It has been discovered that conventional polymer grades suitable for meltblowing that contain species for post polymerization Mw reduction (such as peroxide species) are generally undesirable because such species can accelerate the oxidation of the microporous membrane substrate.

Optionally, the polypropylene is a crystallizable polymer or copolymer. A “crystallizable” polymer or copolymer-distinct from “crystalline”—is a polymer having a measured crystallinity (by DSC) augmented at least by a factor of 1.5, or 2, or 3 by processes such as maintaining the polymer for a period of 120 hours at ambient temperature before melt-blowing, by singly or repeatedly mechanically distending the sample before melt-blowing, or by contacting the polymer with another crystalline polymer such as isotactic polypropylene (iPP) before melt-blowing.

In an embodiment, the polypropylene comprises a first polypropylene (“PP1”) and/or a second polypropylene (“PP2”). PP1 comprises polypropylene having a relatively high Tm in order to provide the thermoplastic film with improved MDT and electrochemical stability over that of the microporous membrane substrate. PP2 comprises polypropylene having a relatively low Tm in order to provide the thermoplastic film with a improved SDT and electrochemical stability over that of the microporous membrane substrate. When the non-woven web is produced from a combination of PP1 and PP2, the non-woven web provides the BSF with improved SDT, improved MDT, and improved electrochemical stability over that of the microporous membrane substrate.

### PP1

PP1 comprises polypropylene homopolymer or copolymer having a Tm ≧149.0° C. Optionally, the PP1 has an Mw ≧1.0×10⁴ (expressed in grams per mole), for example ≧1.0×10⁵ or in the range of from about 1.0×10⁴ to about 2.0×10⁵, such as from about 1.1×10⁴ to about 1.5×10⁵. Optionally, the polypropylene has an MWD ≦50.0, e.g., from about 1.0 to about 30.0, or about 2.0 to about 6.0; and/or a heat of fusion (“ΔHm”) ≧80.0 J/g or ≧1.0×10² J/g, e.g., 90.0 J/g to 120.0 J/g, such as from about 93.0 J/g to 110.0 J/g or from 94.0 J/g to about 108.0 J/g. The polypropylene can be, for example, one or more of (i) a propylene homopolymer or (ii) a copolymer of propylene and ≦1.0 wt. % comonomer.

Optionally, the polypropylene has one or more of the following properties: (i) isotactic tacticity; (ii) a melting peak (“Tm”) ≧149.0° C., e.g., ≧155.0° C., or ≧160° C.; and (iii) a Melt Flow Rate (“MFR”; ASTM D-1238-95 Condition L at 230° C. and 2.16 kg) ≧2.0×10².

Examples of PP1 include Achieve 6936G1™ polypropylene available from ExxonMobil Chemical Company.

### PP2

When the BSF comprises the web and the microporous membrane, the polymer in the web can alter the BSF's permeability by at least partially blocking all or a portion of the membrane's pores at elevated temperature so as to prevent ion flow between the electrodes.

In an embodiment, PP2 comprises polypropylene homopolymer or copolymer having an MFR ≧2.0×10² such as ≧3.0×10², a Tm in the range of 85.0° C. to 130.0° C., and a Te−Tm≦10° C. Optionally, PP2 has an MFR ≧3.5×10² such as ≧4.5×10², e.g., in the range of from 5.0×10² to 4.0×10³, such as 5.5×10² to 3.0×10³; and a Tm in the range of 95.0° C. or 105.0° C. or 110.0° C. or 115.0° C. or 120.0° C. to 123.0° C. or 124.0° C. or 125.0° C. or 127.0° C. or 130.0° C. Optionally, PP2 has an Mw in the range of 1.0×10⁴ to 2.0×10⁵, such as from 1.5×10⁴ to 5.0×10⁴; an MWD ≦50.0 in the range of from 1.4 to 20, e.g., 1.5 to 5.0; a ΔHm ≧40.0 J/g, e.g., in the range of 40.0 J/g to 85.0 J/g, such as in the range of 50.0 J/g to 75.0 J/g; a density in the range of from 0.850 g/cm³ to 0.900 g/cm³, such as from 0.870 g/cm³ to 0.900 g/cm³ or 0.880 g/cm³ to 0.890 g/cm³; a crystallization temperature (“T_{c”}) in the range of from 45° C. or 50° C. to 55° C. or 57° C. or 60° C. Optionally, PP2 has a single-peak melting transition as determined by DSC, with no significant shoulders.

In an embodiment, PP2 is a copolymer of propylene-derived units and ≦10.0 mol. %, e.g., 1.0 mol. % to 10.0 mol. %., of units derived from one or more comonomer such as polyolefin, such as one or more units derived from ethylene and/or one or more C₄-C₁₂ α-olefins. The term “copolymer” included polymers produced using one comonomer species and those produced using two or more comonomer species such terpolymer. Optionally, PP2 is a polypropylene copolymer having a comonomer content is in the range of from 3.0 mol. % to 15 mol. %, or 4.0 mol. % to 14 mol. %, e.g., from 5.0 mol. % to 13 mol. % such as from 6.0 mol. % to 10.0 mol. %. Optionally, when more than one comonomer is present, the amount of a particular comonomer is <1.0 mol. % and the combined comonomer content is ≧1.0 mol. %. Non-limiting examples of suitable copolymers include propylene-ethylene, propylene-butene, propylene-hexene, propylene-hexene, propylene-octene, propylene-ethylene-octene, propylene-ethylene-hexene and propylene-ethylene-butene polymers. In a particular embodiment, the comonomer comprises hexene and/or octene.

In an embodiment, PP2 is a copolymer of propylene and at least one of ethylene, octene, or hexene comonomer, wherein PP2 has an Mw in the range of from 1.5×10⁴ to 5.0×10⁴, and an MWD in the range of from 1.8 to 3.5, a Tm in the range of 100.0° C. to 126.0° C., and a Te−Tm in the range of 2.0° C. to 4.0° C.

PP2 can be produced, e.g., by any convenient polymerization process. Optionally, the PP2 is produced in a single stage, steady state polymerization process conducted in a well-mixed continuous feed polymerization reactor. The polymerization can be conducted in solution, although other polymerization procedures such as gas phase, supercritical, or slurry polymerization, which fulfill the requirements of single stage polymerization and continuous feed reactors, may also be used. PP2 can be prepared by polymerizing a mixture of propylene and optionally one or more other a-olefins in the presence of a chiral catalyst (e.g., a chiral metallocene).

The PP2 can be made in a polymerization process using a Ziegler-Natta or single-site polymerization catalyst. Optionally, the polypropylene is produced in a polymerization process using a metallocene catalyst. For example, PP2 can be produced according to the methods disclosed in U.S. Pat. No. 5,084,534 (such as the methods disclosed therein in examples 27 and 41), which is incorporated by reference herein in its entirety.

### Determining Polypropylene Properties

The polypropylene's melting peak (“Tm”), melting peak endpoint (“Te”), and heat of fusion (“ΔHm”) are determined using differential scanning calorimetry (DSC). The DSC is conducted using a TA Instrument MDSC 2920 or Q1000 Tzero-DSC and data analyzed using standard analysis software. Typically, 3 to 10 mg of polymer is encapsulated in an aluminum pan and loaded into the instrument at room temperature (21° C. to 25° C.) before the DSC measurement. DSC data is then recorded by exposing the sample to a first temperature of −50° C. (the “first cooling cycle”) and then exposing the sample to an increasing temperature at a rate of 10° C./minute to a second temperature of 200° C. (the “first heating cycle”). The sample is maintained at 200° C. for 5 minutes and then exposed to a decreasing temperature at a rate of 10° C./minute to a third temperature of −50° C. (the “second cooling cycle”). The sample temperature is again increased at 10° C./minute to 200° C. (the “second heating cycle”). Tm and Te are obtained from the data of the second heating cycle. Tm is the temperature of the maximum heat flow to the sample in the temperature range of −50° C. to 200° C. Polypropylene may show secondary melting peaks adjacent to the principal peak, and/or the end-of-melt transition, but for purposes herein, such secondary melting peaks are considered together as a single melting point, with the highest of these peaks being considered the Tm. Te is the temperature at which the melting is effectively complete, as determined from the DSC data by the intersection of an initial tangent line and a final tangent line. The initial tangent line is a line drawn tangent to DSC data on the high temperature side of the Tm peak at a temperature corresponding to a heat flow of 0.5 times the maximum heat flow to the sample. The initial tangent line has a negative slope as the heat flow diminishes toward the baseline. The final tangent line is a line drawn tangent to the DSC data along the measured baseline between Tm and 200° C.

Polypropylene density is measured at 23° C. using the method of ASTM D-1505.

The polypropylene's Mw and MWD are determined by the methods disclosed in PCT Patent Application No. US2008/051352.

### Combinations of Polymers

In an embodiment, the non-woven web is produced from combinations of oxidation-protective polymers and/or combinations of oxidation-protective polymers and additional species such as polyethylene. The additional species can be used to add or improve BSF functionalities to the thermoplastic film. For example, the non-woven web can be produced from 5.0 wt. % to 95.0 wt. % of a high-Tm polypropylene (e.g., PP1) and 95.0 wt. % to 5.0 wt. % of (i) a low-Tm polymer (such as PP2) or (ii) polyethylene having a Tm ≦130.0° C. in order to provide the resulting thermoplastic film with a high meltdown temperature, a low shutdown temperature, and electrochemical stability. The weight percents are based on the weight of the polymer used to produce the web. Optionally, the additional species comprises polymer that can be combined with the polypropylene, e.g., in the molten state, and then meltblown, spun-bonded, electro-spun, etc. to produce the non-woven web. In an embodiment, the additional species is polyolefin, such as polyethylene polymer or copolymer.

In an embodiment, the additional species comprises polyethylene having a Tm in the range of 85.0° C. to 127° C. and a Te−Tm≦10° C. The term “polyethylene” means a polymer containing recurring ethylene units, such as polyethylene homopolymer and copolymers wherein at least 90% (by number) of the recurring units are ethylene.

Optionally, the polyethylene has a Tm ≧85.0° C., e.g., in the range of from 95.0° C. to 130.0° C., such as 100.0° C. to 126.0° C., or 115.0° C. to 125.0° C., or 121.0° C. to 124.0° C.; and a Te−Tm in the range of 1.0° C. to 5.0, such as from 2.0° C. to 4.0° C. Optionally, the polyethylene has an Mw in the range of from 5.0×10³ to 1.0×10⁵, e.g., in the range of from 1.5×10⁴ to 1.5×10⁵, such as from 1.5×10⁴ to 5×10⁴; and an MWD in the range of from 1.5 to 5.0, e.g., 1.8 to 3.5. Optionally, the polyethylene has a density in the range of 0.900 g/cm³ to 0.935 g/cm³. Polyethylene mass density is determined in accordance with A.S.T.M. D1505.

Optionally, the polyethylene is a copolymer of ethylene and ≦10.0 mol. % of a comonomer such as α-olefin. The comonomer can be, e.g., one or more of propylene, butene-1, pentene-1, hexene-1, 4-methylpentene-1, octene-1, vinyl acetate, methyl methacrylate, styrene, or other monomer. In an embodiment, the comonomer is hexene-1 and/or or octene-1.

Optionally, the polyethylene has a Te−Tm in the range of 1.0° C. to 5.0° C., e.g., in the range of 2.0° C. to 4.0° C. The melting distribution (Te−Tm) is a characteristic of the polyethylene resulting from the polymer's structure and composition. For example, some of the factors influencing melting distribution include the Mw, MWD, branching ratio, the molecular weight of branched chains, the amount of comonomer (if any), comonomer distribution along the polymer chains, the size and distribution of polyethylene crystals in the polyethylene and crystal lattice regularity.

Optionally, the polyethylene has a melt index ≧1.0×10², e.g., in the range of from 125 to 1500, such as from 150 to 1000. It is believed that when polyethylene melt index is ≧100, it is easier to produce the non-woven web, particularly when the non-woven web is produced directly on the microporous membrane. Polyethylene melt index is determined in accordance with ASTM D1238, Condition E, 190° C./2.16 kg.

It has been surprisingly found that combining a microporous membrane substrate and a non-woven web comprising high-Tm polypropylene such as PP 1 and a low-Tm polypropylene or polyethylene as described results in a BSF having improved SDT, MDT, electrochemical stability over that of the microporous membrane substrate, without significantly degrading other desirable substrate properties such as permeability and strength. Optionally, the web can be laminated to one or more different type(s) of non-woven web(s) (e.g., a spunbond web) to, for example, increase the strength of the separator or alter the compressibility of the separator.

### Method for Producing the Non-Woven Web

The non-woven web can be produced by any convenient method, including conventional web-forming methods such as meltblowing, spun bonding, electrospinning, etc. In an embodiment, the non-woven web is produced by meltblowing. While the production of the web will be described in terms of the following meltblowing process, the invention is not limited thereto, and the description of these meltblowing embodiments is not meant to foreclose other embodiments within the broader scope of the invention such as other meltblowing processes, spun bonding processes, electrospinning processes, etc.

Meltblowing produces a web of fibers formed by extruding a molten polymer through a plurality of fine, usually circular, die capillaries as molten threads or filaments into converging, usually hot and high velocity, gas streams (e.g., air or nitrogen) to attenuate the filaments of molten polymer and form fibers. The diameter of the molten filaments is reduced by the drawing air to achieve a desired size. Thereafter, the meltblown fibers are carried by the high velocity gas stream and are deposited on a collecting surface to form at least one web of randomly-disbursed meltblown fibers.

In an embodiment, the molten polymer comprises polypropylene, optionally ≧90.0 wt. % PP1 or ≧90.0 wt. % PP2, based on the weight of the molten polymer. In another embodiment, the molten polymer comprises 5.0 wt. % or 10.0 wt. % or 25.0 wt. % or 75.0 wt. % or 90.0 wt. % to 95.0 wt. % or 90.0 wt. % or 75.0 wt. % or 25.0 wt. % or 10.0 wt. % PP1 with the balance being substantially PP2. In yet another embodiment, the molten polymer comprises PP1 and polyethylene, the polyethylene having a Tm ≦130.0° C., e.g., in the range of 95° C. to 130° C., and a Te−Tm≦10° C., e.g., in the range of 1.0° C. to 5.0° C.

The meltblown fibers can be continuous or discontinuous and are generally smaller than 10.0 μm in average diameter. For example, In an embodiment, the fibers have an average diameter in the range of 0.2 μm to 10.0 μm, such as 0.3 μm to 0.8 μm when relatively small diameter fibers are desired, or 0.5 μm to 8.0 μm when larger diameter fibers are desired. Average fiber length is generally continuous, with a ratio of fiber length to fiber diameter ≧1.0×10³, e.g., ≧1.0×10⁴. Optionally, when relatively small diameter fibers are desired, maximum fiber diameter is in the range of 1.0 μm to 5.0 μm, minimum fiber diameter is in the range of 0.03 μm to 0.20 μm, and median fiber diameter is in the range of 0.3 μm to 0.7 μm with a standard deviation in the range of 0.2 to 0.8.

During meltblowing, molten polymer is provided to a die that is disposed between a pair of air plates that together form a primary air nozzle. Alternatively, air can be provided in an annular arrangement instead of or in addition to the air plates. Standard meltblown equipment includes a die tip with a single row of capillaries along a knife edge. The die tips can have, e.g., approximately 30 capillary exit holes per linear inch (25.4 mm) of die width. The number of capillary exit holes per linear measure of die width is not critical, and can be, e.g., ≦1 capillary exit hole per linear cm, e.g., in the range of 1 to 100, such as in the range of 5 to 50 capillary exit holes per linear cm of die width. The die tip is typically a 60° wedge-shaped block converging at the knife edge at the point where the capillaries are located. Optionally, the air plates are mounted in a recessed configuration such that the tip of the die is set back from the primary air nozzle. Alternatively, the air plates can be mounted in a flush configuration where the air plate ends are in the same horizontal plane as the die tip; or in a protruding or “stick-out” configuration where the tip of the die extends past the ends of the air plates. Optionally, more than one air flow stream can be used.

Hot air is provided through the primary air nozzle formed on each side of the die tip. The hot air heats the die and thus prevents the die from clogging with solidified polymer as the molten polymer exits and conducts heat away from the die. The hot air also draws, or attenuates, the melt into fibers. Alternatively, heated gas can be used to maintain polymer temperature in the polymer reservoir, as is disclosed in U.S. Pat. No. 5,196,207. Secondary, or quenching, air at a temperature above ambient can be provided through the die head if desired. Optionally, the primary hot air flow rate is in the range of from about 9.5 liters/sec. to 11.3 liters/sec. per 2.54 cm of die width (approximately 20 to 24 standard cubic feet per minute, “SCFM”, per inch of die width). When the melt-blown web is produced on a microporous membrane (used, e.g., as a substrate), the primary hot air flow rate should be in the range of 3.75 liters/sec to 8.0 liters/sec. per 2.5 cm of die width (approximately 8 to 17 SCFM per inch of die width).

Optionally, the air pressure of the primary hot air is in the range of from 115 kPa or 140 kPa to 160 kPa or 175 kPa or 205 kPa at a point in the die head just prior to exit. Optionally, the primary hot air temperature is 450° C. or 400° C., e.g., in the range of 200° C. or 230° C. to 300° C. or 320° C. or 350° C. The particular temperature selected for the primary hot air flow will depend on the particular polymer being drawn. The primary hot air temperature and the polymer's melt temperature are selected to be sufficient to form a melt of the polymer but below the polymer's decomposition temperature. Optionally, the melt temperature is in the range of from 200° C. or 220° C. to 280° C. or 300° C. Optionally, polymer throughput is in the range of from 0.10 grams per hole per minute (ghm) or 0.2 ghm or 0.3 ghm to 1.0 ghm or 1.25 ghm, expressed in terms of the amount of composition flowing per inch (25.4 mm) of the die per unit of time. In an embodiment where the die has 12 holes/cm, polymer throughput is optionally about 2.3 kg/cm/hour to 6.0 kg/cm/hour or 8.0 kg/cm/hour or 9.5 kg/cm/hour. Optionally, the polymer is meltblown at a melt temperature in the range of from 220° C. or 240° C. to 280° C. or 300° C.; and a throughput within the range of from 0.1 or 0.2 ghm to 1.25 ghm or 2.0 ghm.

Since the die operates at high temperature, it can be advantageous to use a cooling medium such as cooled gases (e.g., air) to accelerate cooling and solidification of the meltblown fibers. In particular, secondary air flowing in a cross-flow (e.g., substantially perpendicular, or 90°) direction relative to the direction of fiber elongation (“attenuating air flow”), can be used to quench meltblown fibers. Using such secondary air can make it easier to produce relatively small diameter fibers, e.g., in the range of 2.0 μm to 5.0 μm. In addition, a cooler pressurized quench air may be used and can result in faster cooling and solidification of the fibers. Through the control of air and die tip temperatures, air pressure, and polymer feed rate, the diameter of the fiber formed during the meltblown process may be regulated. In one or more embodiments, meltblown fibers produced herein have a diameter within the range of 0.5 μm or 1.0 μm or 2.0 μm to 3.0 μm or 5.0 μm or 10.0 μm, wherein ≧50% of the fibers have a diameter ≧1.0 μm based on the total number of fibers in the non-woven web.

The meltblown fibers are collected to form a non-woven web. In an embodiment, the fibers are collected on a forming web that includes a moving mesh screen or belt located below the die tip. In order to provide enough space beneath the die tip for fiber forming, attenuation and cooling, a web-forming distance of about 200.0 mm to 300.0 mm is provided between the die tip and the top of the substrate (e.g., a mesh screen). Web-forming distances as low as 100.0 mm can be used. When the web is formed on a microporous membrane (e.g., when the membrane is a substrate), the web-forming distance is 150.00 mm, e.g., in the range of 50.0 to 150.0 mm, such as 75.0 mm to 125.0 mm. The shorter web-forming distances may be achieved using an attenuating air flow that is at least 30.0° C. cooler than the temperature of the molten polymer in the die. Optionally, the web is formed directly upon another fabric and then laminated with the membrane. Additional details can be found in U.S. Pat. No. 3,978,185 which is incorporated by reference herein in its entirety.

### Composite Structure

In an embodiment, the non-woven web is combined with a microporous membrane by, e.g., lamination or by producing the web on the membrane, where the phrase “producing the web on the membrane” means that the non-woven polymeric web is meltblown onto the microporous membrane. In other words, in an embodiment where the web is produced on the membrane, the non-woven polymeric web is formed at the time it is applied to the microporous membrane. The combined web and microporous membrane, e.g., in the form of a layered thermoplastic film, is useful as battery separator film. A second non-woven web can be combined with the microporous membrane, if desired. The second web, which can be produced by the same methods and from the same materials as the first web, can be combined with the microporous membrane by, e.g., lamination or producing the second web on the first web or on a second surface of the microporous membrane.

For example, in one embodiment, the non-woven web is applied directly to a finished microporous membrane substrate using a meltblown process. In this embodiment, a forming belt coveys the substrate continuously into a meltblowing region where a meltblown stream comprising the polypropylene produces a non-woven web on the substrate to form a BSF having a composite structure comprising the membrane and a meltblown layer. The meltblown process allows facile adjustment of the fiber diameter and the web basis weight. Optionally, the substrate is conducted to one or more additional meltblowing region where additional non-woven webs are produced on the composite. The composite can be inverted so that the additional non-woven web is produced on a side of the substrate opposite the first non-woven web. Accordingly, in an embodiment meltblown polymer can be applied to one or both sides of the membrane, e.g., in layered arrangements such as A/S, A/S/A, B/S, B/S/B, A/B/S/A, A/B/S/B/A, A/B/S/A/B, etc., where S represent the microporous membrane substrate, A represents a non-woven web comprising polypropylene, and B represents (i) a second microporous membrane, (ii) a second non-woven web comprising polymer such as polyolefin, and/or (iii) a porous or microporous coating such as a coating comprising an inorganic material. Additional microporous membranes or additional layers C, D, E, etc., can be used on and/or interleaved with A, B, and S to provide other desirable BSF functionalities such as improved strength, increased MDT, etc. Additional membrane substrates can be combined with the composite to produce thermoplastic film having an A/S1/A/S2/(A, S1, B, or C) structure, an A/S1/B/S2/(A, S2, S3, C, or D), or combinations and continuations (repeating or otherwise) thereof. In these exemplary structures, A represents a non-woven web, S1, S2, etc. represent microporous membrane(s), B represents a second non-woven web, and C represents either a non-woven web or a microporous membrane substrate.

In an embodiment, the membrane has an A/S structure where A represents a non-woven web comprising polypropylene, the web providing the BSF with (i) improved shutdown temperature and electrochemical stability over that of the membrane substrate S, (ii) improved meltdown temperature and electrochemical stability over that of the membrane substrate S, or (iii) improved shutdown temperature, improved meltdown temperature, and improved electrochemical stability over that of membrane substrate S. Such a membrane is useful when improved BSF electrochemical stability is needed in proximity to one battery electrode only (e.g., the cathode), and has the advantage that the BSF can be made thinner than an equivalent A/S/A membrane which is also within the scope of the invention.

In another embodiment, the membrane has an A/S/B structure or A/B/S structure where A represents non-woven web comprising polypropylene, the A web providing improved meltdown temperature and electrochemical stability over that of the membrane substrate S; and B represents a non-woven web comprising polyethylene, the B web providing the BSF with a improved SDT but generally without a significant improvement in electrochemical stability compared to that of the substrate S. While embodiments such as B/A/S are within the scope of the invention, the A/B/S and A/S/B embodiments are more typical because the shutdown-improvement polymer of the B web is in closer proximity to the substrate S's pores, for more efficient operation of the shutdown functionality.

In an embodiment, the non-woven web comprises a mat of meltblown fibers having a basis weight ≧1.0 g/m², e.g., in the range of 1.0 g/m² to 50.0 g/m², a thickness of ≦75.0 μm, e.g., in the range of 0.10 μm to 20.0 μm, and an average pore size (i.e., equivalent diameter) of 0.30 μm to 50.0 μm. The fibers can have diameters, e.g., in the range of 0.10 μm to 13.0 μm with a majority (>50.0% by number) of the fibers having diameters ≧0.1 μm, and having lengths that are nearly continuous, e.g., ≧12.0 millimeters. Optionally, the web is produced on the microporous membrane substrate (e.g., the web and substrate are not laminated), wherein the web's basis weight is in the range of from 1.0 g/m² to 5.0 g/m² and the web's thickness is in the range of from 1.0 μm to 10.0 μm. Such a web has a significantly smaller basis weight than those disclosed in U.S. Pat. No. 6,692,868, where the disclosed web imparts a shutdown functionality to the BSF.

Optionally, the web's average pore size is in the range of from 1.0 μm to 25.0 μm and the web's fibers have average diameters in the range of 0.5 μm to 10.0 μm, with ≧85% of the fibers (by number) having diameters ≧0.1 μm, such as in the range of 1.0 μm to 10.0 μm. The web can have a basis weight in the range of from 1.0 to 50.0 g/m², such as in the range of 4.0 g/m² to 35.0 g/m², a thickness of 75.0 μm, and an average pore size of 0.30 to 50.0 μm. Optionally, average fiber length divided by average fiber diameter is ≧1.0×10³; e.g., in the range of 1.0×10⁴ to 1.0×10⁷. The ratio of average fiber length to average fiber diameter can be measured, e.g., by photo-microscopy during fiber deposition. In one embodiment, the web has a basis weight in the range of 1.0 g/m² to 5.5. g/m² and a thickness in the range of 1.0 μm to 25 μm. Such non-woven webs are useful for producing relatively thin BSFs as are desired for lithium ion secondary batteries having a small form factor, small volume, high MDT, and low SDT; but with large storage capacity and discharge rates.

Fiber diameter is measured using Scanning Electron Microscope (SEM) image analysis as follows. A sample comprising the non-woven web (e.g., the web alone or combined with the thermoplastic film) is cut to a size of about 3 mm×3 mm and mounted on the SEM observation stage using adhesive tape. Platinum is deposited on the sample (current of 20 mA for 40 sec) in a vacuum chamber at a pressure ≦10 Pa.

Following platinum deposition, the SEM stage is mounted on a field emission scanning electron microscope (e.g., SEM JSM-6701F available from JEOL co. Ltd.). Images are obtained at magnification factors in the range of 0.25K to 30K, using an acceleration voltage of 2 KV and exposure current of 7 MA. Fiber and web characteristics are measured directly from the images using the methods described in C. J. Ellison, et al., Polymer 48 (2007) 3306-3316.

### Microporous Membrane

In an embodiment, the microporous membrane is an extrudate produced from at least one diluent and at least one polyolefin. The polyolefin can be, e.g., ethylene, polypropylene, homopolymers thereof and copolymers thereof. In one embodiment, the extrudate includes a first polyethylene and/or a second polyethylene and/or a polypropylene, each described below. Optionally, the microporous membrane has a thickness in the range of 3.0 μm to 50.0 μm.

Although the microporous membrane is described in terms of a “wet” process (e.g., the microporous membrane is produced from a mixture of polymer and diluent), the invention is not limited thereto, and the following description is not meant to foreclose other microporous membranes within the broader scope of the invention, such as membranes made in a “dry” process using little or no diluent.

### The First Polyethylene

The first polyethylene has an Mw ≦1.0×10⁶, e.g., in the range of from about 1.0×10⁵ to about 9.0×10⁵, for example from about 2.0×10⁵ to about 8.0×10⁵. Optionally, the polyethylene has an MWD ≦1.0×10², e.g., in the range of from about 1.0 to about 50.0, such as from about 3.0 to about 20.0. For example, the first polyethylene can be one or more of a high density polyethylene (“HPDE”), a medium density polyethylene, a branched low density polyethylene, or a linear low density polyethylene.

In an embodiment, the first polyethylene has an amount of terminal unsaturation ≧0.20 per 10,000 carbon atoms, e.g., ≧5.0 per 10,000 carbon atoms, such as ≧10.0 per 10,000 carbon atoms. The amount of terminal unsaturation can be measured in accordance with the procedures described in PCT Publication WO97/23554, for example.

In an embodiment, the first polyethylene is at least one of (i) an ethylene homopolymer or (ii) a copolymer of ethylene and ≦10 mol. % of a comonomer such as polyolefin. The comonomer can be, for example, one or more of propylene, butene-1, pentene-1, hexene-1, 4-methylpentene-1, octene-1, vinyl acetate, methyl methacrylate, or styrene.

### The Second Polyethylene

The second polyethylene has an Mw >1.0×10⁶, e.g., in the range of 1.1×10⁶ to about 5.0×10⁶, for example from about 1.2×10⁶ to about 3.0×10⁶, such as about 2.0×10⁶. Optionally, the second polyethylene has an MWD ≦1.0×10², e.g., from about 2.0 to about 1.0×10², such as from about 4.0 to about 20.0 or about 4.5 to 10. For example, the second polyethylene can be an ultra-high molecular weight polyethylene (“UHMWPE”). In an embodiment, the second polyethylene is at least one of (i) an ethylene homopolymer or (ii) a copolymer of ethylene and ≦10.0 mol. % of a comonomer such as polyolefin. The comonomer can be, for example, one or more of propylene, butene-1, pentene-1, hexene-1, 4-methylpentene-1, octene-1, vinyl acetate, methyl methacrylate, or styrene. Such a polymer or copolymer can be produced using a single-site catalyst.

The Mw and MWD of the first and second polyethylenes are determined using the procedure described in the production of the non-woven web.

### The Polypropylene

The polypropylene has an Mw ≧1.0×10⁵, for example ≧1.0×10⁶, or in the range of from about 1.05×10⁶ to about 2.0×10⁶, such as from about 1.1×10⁶ to about 1.5×10⁶. Optionally, the polypropylene has an MWD ≦100, e.g., from about 1.0 to about 50.0, or about 2.0 to about 6.0; and/or a heat of fusion (“ΔHm”) ≧80.0 J/g, e.g., 110.0 J/g to 120.0 J/g, such as from about 113.0 J/g to 119.0 J/g or from 114.0 J/g to about 116.0 J/g. The polypropylene can be, for example, one or more of (i) a propylene homopolymer or (ii) a copolymer of propylene and 10.0 mol. % of a comonomer. The copolymer can be a random or block copolymer. The comonomer can be, for example, one or more of a-olefins such as ethylene, butene-1, pentene-1, hexene-1, 4-methylpentene-1, octene-1, vinyl acetate, methyl methacrylate, and styrene, etc.; and diolefins such as butadiene, 1,5-hexadiene, 1,7-octadiene, 1,9-decadiene, etc. Optionally, the polypropylene is selected from among those disclosed in WO2007/132942, WO2007/1329423, WO2008/140835, WO2008/026782, and WO2008/026780 which are incorporated by reference herein in their entirety.

The properties of the polymers used to produce the extrudate (and consequently the microporous membrane), such as ΔHm, Mw, and MWD, Tm, etc. can be determined by the methods disclosed in PCT Patent Publication No. WO2008/140835.

In an embodiment, the polyolefin used to produce the extrudate comprises the first and second polyethylenes. For example, the extrudate can be produced from a polyolefin comprising the first polyethylene in an amount ≧50.0 wt. %, e.g., in the range of from 60.0 wt. % to 99.0 wt. %, such as from about 70.0 wt. % to about 90.0 wt. % and the second polyethylene in an amount <50.0 wt. %, e.g., in the range of from 1.0 wt. % to 45.0 wt. %, such as from about 10.0 wt. % to about 40.0 wt. %. The weight percents of the first and second polyethylenes are based on the weight of the polymer used to produce the extrudate. In an embodiment, In an embodiment, the polyolefin used to produce the extrudate further comprises <50.0 wt. % polypropylene, e.g., in an amount in the range of from 1.0 wt. % to 50.0 wt. %, such as from about 2.5 wt. % to about 40.0 wt. %, or from about 5.0 wt. % to about 30.0 wt. %

### Extrudate

The extrudate is produced by combining polymer and at least one diluent. The amount of diluent used to produce the extrudate can be in the range, e.g., of from about 25.0 wt. % to about 99.0 wt. % based on the weight of the extrudate, with the balance of the weight of the extrudate being the polymer used to produce the extrudate, e.g., the combined first polyethylene and second polyethylene.

The diluent is generally compatible with the polymers used to produce the extrudate. For example, the diluent can be any species capable of forming a single phase in conjunction with the resin at the extrusion temperature. Optionally, the diluent is a paraffinic hydrocarbon (e.g., liquid paraffin) having a kinetic viscosity of 20-200 cSt at 40° C. The diluent can be the same as those described in U.S. Patent Publication Nos. 2008/0057388 and 2008/0057389, both of which are incorporated by reference in their entirety.

Optionally, the extrudate (and the resulting microporous membrane) contain non-polymeric species (such as inorganic species containing silicon and/or aluminum atoms), and/or heat-resistant polymers such as those described in PCT Publication WO 2008/016174.

The microporous membrane generally comprises the polyolefin used to produce the extrudate. A small amount of diluent or other species introduced during processing can also be present, generally in amounts less than 1 wt. % based on the weight of the microporous membrane. A small amount of polymer molecular weight degradation might occur during processing, but this is acceptable.

In an embodiment, the microporous membrane contains polypropylene in an amount <0.1 wt. %, based on the weight of the microporous membrane. Such a membrane can comprise, for example, (a) from 1.0 wt. % to 50.0 wt. %, e.g., from about 10.0 wt. % to about 40.0 wt. %, of the second polyethylene; and (b) from 50.0 wt. % to 99.0 wt. %, e.g., from about 60.0 wt. % to about 90.0 wt. % of the first polyethylene; the first polyethylene having an Mw ≦1.0×10⁶, e.g., in the range of from about 1.0×10⁵ to about 9.0×10⁵, such as from about 4.0×10⁵ to about 8.0×10⁵, and an MWD ≦1.0×10², e.g., in the range of from about 1.0 to about 50.0, such as from about 3.0 to about 20.0; and the second polyethylene having an Mw >1.0×10⁶, e.g., in the range of 1.1×10⁶ to about 5.0×10⁶, such as from about 1.2×10⁶ to about 3.0×10⁶, and an MWD ≦1.0×10², e.g., from about 2.0 to about 50.0, such as from about 4.0 to about 20.0.

Optionally, the fraction of polyolefin in the membrane having an Mw >1.0×10⁶ is at least 1 wt. %, based on the weight of the polyolefin in the membrane, e.g., at least 2.5 wt. %, such as in the range of about 2.5 wt. % to 50.0 wt. %.

### Method of Producing the Microporous Membrane

In one or more embodiments, the microporous membrane is produced by a process comprising: combining polymer and diluent, extruding the combined polymer and diluent through a die to form an extrudate; optionally cooling the extrudate to form a cooled extrudate, e.g., a gel-like sheet; stretching the cooled extrudate in at least one planar direction, or both; removing at least a portion of the diluent from the extrudate or cooled extrudate to form the membrane. Optionally, the process includes removing any remaining volatile species from the membrane; stretching the membrane, and/or heat setting the membrane. Optionally, the extrudate can be heat set before diluent removal, e.g., after extrudate stretching.

Optionally, the membrane can be subjected to a hot solvent treatment, cross-linking, hydrophilic treatment, etc.

The membrane can be produced by the methods disclosed in PCT publications WO2007/132942, WO2007/1329423, WO2008/140835, WO2008/026782, and WO2008/026780. While the membrane can be produced according to processes disclosed in these references, the invention is not limited thereto. Any method capable of producing a microporous polymeric membrane can be used, including “dry” processes in which little or no diluent is used.

While the membrane can have a monolayer structure, the invention is not limited thereto. The non-woven polymeric web can be produced on multilayer membranes such as those disclosed in WO2008/016174, which is incorporated by reference herein in its entirety. Such multilayer membranes can have layers comprising polyolefin, such as polyethylene and/or polypropylene. The polyolefin used to produce the multilayer membrane can be the same as those described herein for the monolayer membrane. In an embodiment, the multilayer membranes are be produced by coextruding mixtures of polymer and diluent and then removing at least a portion of the diluent (a “wet” process), by laminating extrudates containing polymer and diluent and then removing the diluent, by laminating microporous membranes produced in a wet process, by laminating microporous membranes produced in a dry process, by laminating non-porous membranes and then introducing porosity by membrane orientation (e.g., stretching), etc., and combinations thereof.

In an embodiment, the membrane is used as a substrate or support for the production of the non-woven polymeric web.

### Structure and Properties of the Thermoplastic Film

The thermoplastic film comprises at least one non-woven polymeric web and at least one microporous membrane. Optionally, the web and the membrane are in planar (e.g., face-to-face) contact.

In one or more embodiments, the thermoplastic film comprises the non-woven web produced on or laminated with the microporous membrane. The thickness of the thermoplastic film is generally in the range of from about 1.0 μm to about 1.0×10² μm, e.g., from about 5.0 μm to about 35.0 μm. The thickness of the thermoplastic film can be measured by a contact thickness meter at 1 cm longitudinal intervals over the width of 20 cm, and then averaged to yield the membrane thickness. Thickness meters such as the Litematic available from Mitsutoyo Corporation are suitable. Non-contact thickness measurements are also suitable, e.g., optical thickness measurement methods.

In an embodiment, the invention relates to a thermoplastic film, comprising:
(i) a microporous membrane comprising from 50.0 wt. % to 99.0 wt. % of a first polyethylene and from 1.0 wt. % to 50.0 wt. %, of a second polyethylene; the first polyethylene having an Mw ≦1.0×10⁶, e.g., in the range of from about 1.0×10⁵ to about 9.0×10⁵ and the second polyethylene having an Mw >1.0×10⁶, e.g., in the range of 1.1×10⁶ to about 5.0×10⁶, such as from about 1.2×10⁶ to about 3.0×10⁶, and an MWD ≦1.0×10², e.g., from about 2.0 to about 50.0, such as from about 4.0 to about 20.0; and
(ii) a non-woven web comprising a plurality of fibers having diameters in the range of 0.5 μm to 5.0 μm, the fibers comprising a first polypropylene having a Tm in the range of 85.0° C. to 130.0° C. and a Te−Tm≦10° C. and/or a second polypropylene having a Tm ≧149.0° C. and a ΔHm ≧80.0 J/g;
the non-woven web being bonded to the microporous membrane by laminating the web on a planar surface of the membrane or by producing the web on a planar surface of the membrane by depositing the webs fibers on the membrane.

Optionally, the thermoplastic film has one or more of the following properties.

Normalized Air Permeability ≦1.0×10³ sec/100 cm³/20 μm

In one or more embodiments, the thermoplastic film's normalized air permeability (Gurley value, measured according to JIS P8117 and normalized to that of an equivalent thermoplastic film having a thickness of 20 μm) is ≦1.0×10³ seconds/100 cm³/20 μm, e.g., in the range of about 20 seconds/100 cm³/20 μm to about 400 seconds/100 cm³/20 μm. Since the air permeability value is normalized to that of an equivalent film having a thickness of 20 μm, the thermoplastic film's normalized air permeability value is expressed in units of “seconds/100 cm³/20 μm”.

Normalized air permeability is measured according to JIS P8117, and the results are normalized to the permeability value of an equivalent film having a thickness of 20 μm using the equation A=20 μm*(X)/T₁, where X is the measured air permeability of a film having an actual thickness T₁ and A is the normalized air permeability of an equivalent film having a thickness of 20 μm.

In an embodiment the thermoplastic film's normalized air permeability is ≦(i.e. the same or more permeable than) the microporous membrane substrate's normalized air permeability. Optionally, the thermoplastic film's normalized air permeability is in the range of 0.15 to 0.90 times the microporous membrane substrate's air permeability.

### Porosity

In one or more embodiments, the thermoplastic film has a porosity ≧25%, e.g., in the range of about 25% to about 80%, or 30% to 60%. The thermoplastic film's porosity is measured conventionally by comparing the film's actual weight to the weight of an equivalent non-porous film of the same composition (equivalent in the sense of having the same length, width, and thickness). Porosity is then determined using the formula: Porosity %=100×(w2−w1)/w2, wherein “w1” is the actual weight of the thermoplastic film and “w2” is the weight of the equivalent non-porous film having the same size and thickness.

### Normalized Pin Puncture Strength

In one or more embodiments, the thermoplastic film has a normalized pin puncture strength ≧1.0×10³ mN/20 μm, e.g., in the range of 1.1×10³ mN/20 μm to 1.0×10⁵ mN/20 μm. Pin puncture strength is defined as the maximum load measured at a temperature of 23° C. when a thermoplastic film having a thickness of T₁ is pricked with a needle of 1 mm in diameter with a spherical end surface (radius R of curvature: 0.5 mm) at a speed of 2 mm/second. The pin puncture strength (“S”) is normalized to the pin puncture strength of an equivalent film having a thickness of 20 μm using the equation S₂=20 μm*(S₁)/T₁, where S₁ is the measured pin puncture strength, S₂ is the normalized pin puncture strength, and T₁ is the average thickness of the thermoplastic film.

### Tensile Strength

In one or more embodiments, the thermoplastic film has an MD tensile strength ≧95,000 kPa, e.g., in the range of 95,000 to 110,000 kPa, and a TD tensile strength ≧90,000 kPa, e.g., in the range of 90,000 kPa to 110,000 kPa. Tensile strength is measured in MD and TD according to ASTM D-882A.

### Tensile Elongation

Tensile elongation is measured according to ASTM D-882A. In one or more embodiments, the thermoplastic film's MD and TD tensile elongation are each ≧100%, e.g., in the range of 125% to 350%. In another embodiment, the thermoplastic film's MD tensile elongation is in the range of, e.g., 125% to 250% and TD tensile elongation is in the range of, e.g., 140% to 300%.

### Shutdown Temperature

The thermoplastic film's shutdown temperature is measured by the method disclosed in PCT Publication No. WO2007/052663, which is incorporated by reference herein in its entirety. According to this method, the thermoplastic film is exposed to an increasing temperature (5° C./minute beginning at 30° C.) while measuring the film's air permeability. The thermoplastic film's shutdown temperature is defined as the temperature at which the film's air permeability (Gurley Value) first exceeds 1.0×10⁵ seconds/100 cm³. The film's air permeability is measured according to JIS P8117 using an air permeability meter (EGO-1T available from Asahi Seiko Co., Ltd.).

In an embodiment, the thermoplastic film has a shutdown temperature 138.0° C., e.g., in the range of 120.0° C. to 130.0° C., e.g., in the range of from 124.0° C. to 129.0° C.

### MD and TD Heat Shrinkage at 105° C.

In one or more embodiments, the thermoplastic film has MD and TD heat shrinkages at 105° C. ≦10.0%, for example from 1.0% to 5.0%. The thermoplastic film's shrinkage in orthogonal planar directions (e.g., MD or TD) at 105° C. is measured as follows:

(i) Measure the size of a test piece of thermoplastic film at ambient temperature in both MD and TD, (ii) expose the test piece to a temperature of 105° C. for 8 hours with no applied load, and then (iii) measure the size of the thermoplastic film in both MD and TD. The heat (or “thermal”) shrinkage in either the MD or TD can be obtained by dividing the result of measurement (i) by the result of measurement (ii) and expressing the resulting quotient as a percent.

In one or more embodiments, the membrane has a TD heat shrinkage at 105° C. ≦10%, for example from 0.5% to 5.0%.

### Meltdown Temperature

The thermoplastic film's meltdown temperature is measured by exposing the thermoplastic film to an increasing temperature (5° C./minute beginning at 30° C.) while measuring the thermoplastic film's air permeability (Gurley value). The thermoplastic film's air permeability will decrease and plateau at a Gurley value ≧100,000 seconds/100 cm³ at temperatures above the thermoplastic film's shutdown temperature. As the temperature increases further, the thermoplastic film's air permeability will abruptly increase until a baseline value of approximately 0 seconds/100 cm³ is achieved. The thermoplastic film's meltdown temperature is defined as the temperature at which the film's air permeability (Gurley Value) first passes a Gurley value of 100,000 seconds/100 cm³ as the Gurley value decreases to the baseline value. The thermoplastic film's air permeability is measured according to JIS P8117 using an air permeability meter (EGO-1T available from Asahi Seiko Co., Ltd.). In an embodiment, the film has a meltdown temperature ≧145.0° C., e.g., in the range of 150° C. to 200° C., such as 175° C. to 195° C.

### Electrochemical Stability

Electrochemical stability is a membrane property related to the membrane's resistance to oxidation when the membrane is used as a BSF in a battery exposed to relatively high-temperature storage or use. Electrochemical stability has the units of mAh, and a lower value, representing less integrated charge loss during high-temperature storage or overcharging, is generally desired. For automotive batteries, such as those used for starting or powering motor means for moving an electric vehicle or hybrid electric vehicle, and for power tool batteries, an electrochemical stability storage ≦1.0×10² mAh is desired since those relatively high-power, high capacity applications are particularly sensitive to any loss in battery capacity, such as self-discharge losses resulting from electrochemical instability of the BSF. The term “High-capacity” batteries generally means batteries capable of supplying 1 Ampere hour (1 Ah) or more, e.g., 2.0 Ah to 3.6 Ah. Optionally, the thermoplastic film has a electrochemical stability capacity of 80 mAh or less, e.g., in the range of 1.0 mAh to 60 mAh.

To measure membrane storage stability, a membrane having a length (MD) of 70 mm and a width (TD) of 60 mm is located between and anode and cathode having the same planar dimensions as the membrane. The anode is made of natural graphite and the cathode is made of LiCoO₂. An electrolyte is prepared by dissolving LiPF₆ into a mixture of ethylene carbonate (EC) and methylethyl carbonate (EMC) (4/6, V/V) as 1 M solution. The electrolyte is impregnated into the membrane in the region between the anode and the cathode to complete the battery.

The battery is then exposed to an applied voltage of 4.3V while exposed to a temperature of 60° C. for 21 days. Electrochemical stability is defined as the integrated current (in mAh) flowing between the voltage source and the battery over the 21 day period.

The thermoplastic film is permeable to liquid (aqueous and non-aqueous) at atmospheric pressure. Thus, the microporous membrane can be used as a battery separator, filtration membrane, etc. The thermoplastic film is particularly useful as a BSF for a secondary battery, such as a nickel-hydrogen battery, nickel-cadmium battery, nickel-zinc battery, silver-zinc battery, lithium-ion battery, lithium-ion polymer battery, etc. In an embodiment, the invention relates to lithium-ion secondary batteries containing BSF comprising the thermoplastic film.

Such batteries are described in PCT publication WO2008/016174 which is incorporated by reference herein in its entirety.

This invention will be described in more detail with reference to Examples below without intention of restricting the scope of this invention.

### EXAMPLES

Three thermoplastic films are produced on a Reifenhauser 500 mm bicomponent meltblown line. A non-woven web of meltblown fibers are blown onto a commercially-available microporous membrane (Grade E09HMS available from Tonen Chemical Corporation). The microporous membrane substrate has a thickness of 9 μm, a normalized air permeability of 280 sec./100 cm³/20 μm, a basis weight of 6.0 g/m², an electrochemical stability ≧100.0 mAh, a SDT of approximately 131° C. and an MDT of approximately 148° C.

Two linear oxidation-protective resins are used to produce the meltblown fibers. Resin A is commercially available polypropylene (Achieve 6936G1) having an MFR of 1500 and a Tm of 152° C. Resin B is a copolymer of propylene and ≦2.0 mol. % hexene, the copolymer having an MFR of 3500 and a Tm of 106° C. Meltblowing process conditions for producing the thermoplastic films of Examples 1-3 are shown in Table 1.

In example 1, the meltblown web is produced by exposing a first planar surface of the membrane substrate to a meltblowing region wherein meltblowing is conducted by (1) continuously feeding Resin A to an extruder, (2) simultaneously melting the resin and forcing the resin through a spinneret to extrude the resin into fibers; (3) solidifying the fibers by transferring the heat to the surrounding air. In the meltblown process, the spinneret has a single 500 mm row of capillaries, each having a diameter in the range of 0.1 to 0.5 mm. There are 30 capillary exit holes per linear inch (25.4 mm) of die width. The fibers are then deposited on the microporous membrane substrate to produce a non-woven web of Resin A fibers on the microporous membrane substrate. The substrate-web composite is then inverted and a second planar surface of the membrane is exposed to a second meltblowing process conducted under the same conditions as the first meltblowing process but using Resin B instead of Resin A. Properties of the resulting thermoplastic film are measured according to the methods described in the preceding section. For the electrochemical stability measurement, the thermoplastic film is oriented so that the web produced from Resin A is in contact with the anode.

Example 2 is the same as example 1 except that during the electrochemical stability measurement the web produced from Resin A is in contact with the cathode.

Example 3 is the same as example 1, except that a web of Resin B was produced on one planar surface of the substrate, and no web was produced on the substrate's second planar surface.

Properties of the thermoplastic film are listed in Table 2.

TABLE 1

| | | Primary | | | Web- | MB |
|---|---|---|---|---|---|---|
| Exam- | Melt Temp | Air | Primary | Through- | forming | Basis |
| ple | at Die Tip | Temp | Air Flow | put | Distance | Weight |
| No. | (° C.) | (° C.) | (liters/sec) | (ghm) | (mm) | (g/m²) |
| 1 | 220 | 231 | 78.4 | 0.2 | 67 | 3 |
| 2 | 220 | 231 | 78.4 | 0.2 | 67 | 3 |
| 3 | 177 | 154 | 78.4 | 0.1 | 100 | 3 |

TABLE 2

| | | | Shutdown | | | | |
|---|---|---|---|---|---|---|---|
| | | Normalized | and | | Web | Thermoplastic | |
| | Average | Air | Meltdown | | Basis | Film | Electrochemical |
| Example | Thickness | Permeability | Temperature | | weight⁽¹⁾ | Basis weight | Stability |
| No. | μm | Sec./100 cm³/20 μm | ° C. | ° C. | g/m² | g/m² | mAh |
| 1 | 40.9 | 202 | 128.8 | 147.6 | 4.4 | 14.4 | 25 |
| 2 | 40.9 | 202 | 128.8 | 147.6 | 4.4 | 14.4 | 25 |
| 3 | 40.1 | 199 | 129.1 | 147.6 | 7.4 | 13.4 | 50 |

Examples 1-3 demonstrate the successful production of thermoplastic film comprising a microporous membrane substrate and a non-woven polymeric web deposited thereon. The examples show that in all cases the thermoplastic film has improved electrochemical stability and a lower SDT than the microporous membrane substrate without significantly degraded air permeability or meltdown temperature.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

All patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow. Each of the appended claims defines a separate invention, which for infringement purposes is recognized as including equivalents to the various elements or limitations specified in the claims. Depending on the context, all references herein to the “invention” and/or “embodiment” generally refer to certain specific embodiments only. It should be understood embodiments relating to certain aspects of the invention have been described in greater detail. The invention is not limited to these embodiments, versions, and examples.

1. A thermoplastic film comprising:
a microporous polymeric membrane; and
a non-woven web comprising a plurality of fibers, the web being bonded to the microporous polymeric membrane, wherein the fibers comprise oxidation-protective polymer having an MFR ≧2.0×10².

2. The thermoplastic film of claim 1, wherein the non-woven web comprises ≧30.0 wt. % of the oxidation-protective polymer, based on the weight of the non-woven web; and wherein the oxidation-protective polymer comprises a first polypropylene having a Tm ≧149.0° C. and a ΔHm ≧80.0 J/g C and/or a second polypropylene having a Tm of 85.0° C. to 130.0° C. and a Te−Tm≦10° C.

3. The thermoplastic film of claim 2, wherein the fibers comprise the second polypropylene, the second polypropylene comprising (i) polypropylene homopolymer having, an Mw of 1.5×10⁴ to 5.0×10⁴, and an MWD of 1.5 to 5.0 and/or or (ii) a copolymer of propylene and ≦10.0 mol. % of one or more α-olefin comonomers, the copolymer having an Mw of 1.5×10⁴ to 5.0×10⁴, an MWD of 1.8 to 3.5, a Tm of 100.0° C. to 126.0° C., and a Te−Tm of 2.0° C. to 4.0° C.

4. The thermoplastic film of claim 2, wherein the fibers comprise the first polypropylene, the first polypropylene having an Mw ≧1.0×10⁵, and an MWD ≦50.0; the fibers further comprising polyethylene having an Mw in the range of 1.5×10⁴ to 5.0×10⁴, an MWD of 1.5 to 5.0, a Tm of 95.0° C. to 130.0° C., and a Te−Tm of 1.0° C. to 5.0° C.

5. The thermoplastic film of claim 4, wherein the polyethylene is a copolymer of ethylene and ≦10.0 mol. % of hexene-1 or octene-1 comonomer, the copolymer having a Tm of 100.0° C. to 126.0° C., and a Te−Tm of 2.0° C. to 4.0° C.

6. The thermoplastic film of claim 1, wherein the microporous polymeric membrane is a multilayer microporous membrane, and wherein at least one layer of the multilayer microporous membrane comprises the first and/or second polypropylene.

7. The thermoplastic film of claim 1, wherein the non-woven web is bonded to a first planar surface of the microporous polymeric membrane and further comprising a second non-woven web, the second non-woven web being bonded to the first non-woven web or to a second planar surface of the microporous polymeric membrane, wherein the second non-woven web comprises a plurality of fibers comprising polyolefin.

8. The thermoplastic film of claim 7, wherein
the first and second non-woven webs are meltblown webs;
the first meltblown web's fibers comprise the second polypropylene;
the second meltblown web's fibers comprise a copolymer of ethylene and ≦10.0 mol. % of hexene-1 or octene-1 comonomer, an Mw of 1.5×10⁴ to 1.0×10⁵, an MWD of 1.8 to 3.5, a Tm of 100.0° C. to 126.0° C., and a Te−Tm of 2.0° C. to 4.0° C.; and wherein
(i) the first meltblown web is formed on a first planar surface of the microporous polymeric membrane and the second meltblown web is formed on a second planar surface of the microporous polymeric membrane or (ii) the second meltblown web is formed on the first planar surface and the first meltblown web is formed on the second meltblown web.

9. The thermoplastic film of claim 1, wherein the thermoplastic film has a meltdown temperature ≧145.0° C., an electrochemical stability ≦1.0×10² mAh, a shutdown temperature ≦138° C., a normalized air permeability ≦1.0×10³ sec/100 cm³/20 μm, a porosity ≧25%, and a normalized pin puncture strength ≧1.0×10³ mN/20 μm.

10. A battery separator film comprising the thermoplastic film of claim 1.

11. A method for producing a thermoplastic film comprising combining a non-woven web and a microporous polymeric membrane, the web comprising a plurality of fibers, the fibers comprising oxidation-protective polymer having an MFR ≧2.0×10².

12. The method of claim 11, wherein the oxidation-protective polymer comprises a first polypropylene having a Tm ≧149.0° C. and a ΔHm ≧80.0 J/g C and/or a second polypropylene having a Tm of 85.0° C. to 130.0° C. and a Te−Tm≦10° C.

13. The method of claim 12, wherein the polypropylene is the second polypropylene, the second polypropylene comprising (i) polypropylene homopolymer having, an Mw of 1.5×10⁴ to 5.0×10⁴, an MWD of 1.5 to 5.0 and/or (ii) a copolymer of propylene and ≦10.0 mol. % of one or more α-olefin comonomers, the copolymer having an Mw of 1.5×10⁴ to 5.0×10⁴, an MWD of 1.8 to 3.5, a Tm of 100.0° C. to 126.0° C., and a Te−Tm of 2.0° C. to 4.0° C.

14. The method of claim 12, wherein the web is produced by meltblowing the polypropylene at a primary hot air flow rate of 9.5 liters/sec to 11.3 liters/sec per 2.54 cm of die width, a primary hot air pressure of 115 kPa to 205 kPa, a primary hot air temperature of 200° C. to 350° C., and at a throughput rate of 0.01 ghm to 1.25 ghm.

15. The method of claim 11, wherein the polypropylene is a reactor-grade polypropylene, the polypropylene containing ≦0.1 wt. % peroxide based on the weight of the polypropylene.

16. The method of claims 12, wherein the fibers comprise the first polypropylene, the first polypropylene having an Mw ≧5.0×10⁴, and an MWD ≦50.0; the fibers further comprising polyethylene having an Mw of 1.5×10⁴ to 5.0×10⁴ and an MWD of 1.5 to 5.0, a Tm of 95.0° C. to 130.0° C., and a Te−Tm of 1.0° C. to 5.0° C.

17. The method of claim 12, wherein the non-woven web is bonded to a first surface of the microporous polymeric membrane, and wherein the method further comprises combining the microporous polymeric membrane with a second non-woven web, the second non-woven web being bonded to the first non-woven web or to a second surface of the microporous polymeric membrane, the second non-woven web comprising plurality of fibers comprising polyolefin.

18. The method claim 17, wherein
the first and second non-woven webs are meltblown webs;
the first meltblown web's fibers comprise the first polypropylene;
the second meltblown web's fibers comprise a copolymer of ethylene and ≦10.0 mol. % of hexene-1 or octene-1 comonomer, the copolymer having an Mw of 1.5×10⁴ to 1.0×10⁵, an MWD of 1.8 to 3.5, a Tm of 100.0° C. to 126.0° C., and a Te−Tm of 2.0° C. to 4.0° C.; and
(i) the first meltblown web is formed on a first planar surface of the microporous polymeric membrane and the second meltblown web is formed on a second planar surface of the microporous polymeric membrane or (ii) the second meltblown web is formed on the first planar surface and the first meltblown web is formed on the second meltblown web.

19. The thermoplastic film product of claim 11.

20. A battery comprising an anode, a cathode, an electrolyte, and a separator situated between the anode and the cathode, the separator comprising:
a microporous polymeric membrane; and
a non-woven web comprising a plurality of fibers, the web being bonded to the microporous polymeric membrane, wherein the fibers comprise oxidation-protective polymer having an MFR ≧2.0×10².

21. The battery of claim 20, wherein the oxidation-protective polymer comprises a first polypropylene having a Tm ≧149.0° C. and a ΔHm ≧80.0 J/g and/or a second polypropylene having a Tm of 85.0° C. to 130.0° C. and a Te−Tm≦10° C.

22. The battery of claim 21, wherein the fibers comprise the second polypropylene, the second polypropylene comprising (i) polypropylene homopolymer having an Mw of 1.5×10⁴ to 5.0×10⁴, and an MWD of 1.5 to 5.0 and/or or (ii) a copolymer of propylene and ≦10.0 mol. % of one or more α-olefin comonomers, the copolymer having an Mw of 1.5×10⁴ to 5.0×10⁴, an MWD of 1.8 to 3.5, a Tm of 100.0° C. to 126.0° C., and a Te−Tm of 2.0° C. to 4.0° C.

23. The battery of claim 20, wherein the separator has a meltdown temperature ≧145.0° C., an electrochemical stability ≦1.0×10² mAh, a shutdown temperature ≦138° C., a normalized air permeability ≦1.0×10³ sec/100 cm³/20 μm, a porosity ≧25%, and a normalized pin puncture strength ≧1.0×10³ mN/20 μm.

24. The battery of claim 20, wherein the battery is a lithium ion secondary battery.
